(19) United States
(12) Patent Application Publication
(10) Pub. No.: US 2021/0009335 A1
(43) Pub. Date: Jan. 14, 2021

(54) BOTTLE ADAPTER FOR TREATING LIQUID IN THE INTERIOR OF THE BOTTLE

(71) Applicant: Moshe WILSHINSKY, Jerusalem (IL)

(72) Inventor: Moshe WILSHINSKY, Jerusalem (IL)

(21) Appl. No.: 16/980,873

(22) PCT Filed: Mar. 25, 2019
(86) PCT No.: PCT/IL2019/050338

§ 371 Date: Sep. 15, 2020

Related U.S. Application Data
(60) Provisional application No. 62/647,877, filed on Mar. 26, 2018.

(51) Int. Cl. B65D 81/32; A47J 31/00; A47J 31/44; B65D 81/18; B65D 51/18; B65D 51/28; F25D 3/06

(52) U.S. Cl. CPC B65D 81/3216; A47J 31/005; A47J 31/4407; B65D 81/18; B65D 51/18; F25D 2700/16; F25D 3/06; B65D 2251/0078; B65D 2251/0015; F25D 2303/0842; F25D 2331/803; B65D 51/28

(57) ABSTRACT

The Invention constitutes a device for treatment or analysis of the liquid inside a container, comprising: an universal connector having a first part for affixment to a portion of the container and a second part extending from the first part and made integral therewith; and, an active element for affixment to the second part of the universal connector and extending from the second part into an interior storage area of the container, and the active element affecting the characteristics of the liquid or measuring attributes of the liquid.

### FIELD OF THE INVENTION

The invention relates to the beverage industry and, in particular, to a device for monitoring and treating the liquid in a container.

### BACKGROUND OF THE INVENTION

Due to their convenience, it is likely that bottled beverages will be around for much longer.

The consumer demand for bottled water has been steadily increasing for decades. In recent years bottled water out sold all other soft drinks. As consumer tastes have evolved, the demand has caused the evolution of the bottled water market (that are used for other beverages as well) from single use to multiple use plastic bottles, as well as bottles made from various alternative materials including metal, glass paper. Certain functionality started being incorporated into the bottles themselves and they became known as smart bottles. Consumer tastes have continued to evolve, so there are sub markets for premium enhanced waters from natural fruit flavors, to vitamin, mineral as well as caffeine enhanced. The latest trends include the drive for personalized products, and a conscious effort to reduce the consumption of resources. The present invention was inspired by a drive to address all of the above in some form or another.

Accordingly, there is a significantly growing need for water (flavored and unflavored) and necessarily a need to monitor and treat and the water within the container. This is caused by, among other things,
Bottled water demand is growing
Popularity of flavored and/or sparkling water
The need to chill water more efficiently without chilling and storing the entire bottle
Demand for water additives is growing
IOT functions

Among the modern challenges in the beverage industry is accessing the bottle interior. In other words, how do you create value added, premium ingredients (flavor and or vitamin additives or infusion), or “smart” (interactive and/or IOT) in the 10s of millions of single-use and multi-use plastic/glass bottles or Green bottles which are sold around the world. How do you get access to the contents or interior of a bottle without having to provide the bottle?

Another challenge is chilling the liquid in a container. How do you efficiently lower the temperature of the water? It Only Needs to be chilled when the consumer drinks. If you pre-chill the bottles, a large space is needed and the bottles need to sit for a long period of time.

Currently, there are only two devices that can address the issues even partially. You need a smart cap or a smart bottle, but both have limits to what they can do and/or how they can be distributed. Use of either or other solutions creates further challenges, such as the need to keep bottles cold, takes up significant space, IOT require smart bottles or smart caps, how to add nutrients etc. to the water, enabling cheap eco-friendly bottles to be smart.

Therefore, there is a need for a device that can simply and effectively treat and/or monitor the attributes of a liquid in a container.

### SUMMARY OF THE INVENTION

These and other objects of the Invention can be obtained by a device for treatment or analysis of the liquid inside a container, comprising: an universal connector having a first part for affixment to a portion of the container and a second part extending from the first part and made integral therewith; and, an active element for affixment to the second part of the universal connector and extending from the second part into an interior storage area of the container, and the active element affecting the characteristics of the liquid or measuring attributes of the liquid.

According to an embodiment, the device further comprises means for electronically connecting to an external device for sharing relevant information about the liquid or displaying the relevant information on the external device or the external device controlling functioning of said active element. The external device may be, inter alia, a personal computing device, a smart phone, a tablet, a laptop computer, a desktop computer, wearable monitoring devices, IoT interrelated devices, or information services accessible via the Cloud or Internet or Computer networks

In another embodiment, the active element includes monitoring or sensing elements monitoring ingredients of the liquid or flow of the liquid or measuring chemical composition, acidity or temperature of the liquid. The active element may be, inter alia, an infuser, a heating element, a cooling element or an heat exchange device. Further, the active element can provide colorings, flavorings, vitamins, alcohol, additives, infusions, mineral supplements or pharmaceutically active ingredients into the liquid.

According to an embodiment, the universal connector engages the container between a neck and a lid of the container. The universal connector can have a first screw thread for engaging a screw thread around the neck of the container, and a second screw thread for affixment of the active element to the universal connector. Additionally, the universal connector can engage the container by a friction or snap fitting or the active member engages the universal connector by a friction or snap fitting. Moreover, an adapter ring facilitates affixment of the universal connector to the container. The first part of said universal connector can be an gasket for flexibly engaging threads of any of a range of container sizes or shapes.

Another embodiment includes an extender having a first end for affixment to the universal connector and a second end for affixment to the active member. The first end of the extender can have a larger diameter than the second end of the extender, thereby effectively lowering said active member further into the interior storage area of the container and spacing the active member from a neck of the container, thereby facilitating flow of liquid through and out of the container.

In some embodiments, there is additionally a centering connector. The centering connector has a first end for affixment to the universal connector and a second end for affixment to the active member, thereby facilitating flow of liquid through and out of the container.

In another embodiment, the universal connector consists of a resilient member with a central opening throughout its length.

In another embodiment, support legs position or hold the universal connector or active member within the interior of the container.

According to one embodiment, the universal connection includes a sleeve and the active member is within the sleeve and includes means for treatment or analysis of the liquid.

Another embodiment includes A system for treatment or analysis of the liquid inside a container, comprising: a preformed container having a longitudinal compartment extending up into an interior storage area of the container and the compartment having an opening contiguous with a bottom portion of said container; and, an active element for affixment to the opening of the compartment and extending within said compartment into said interior storage area of said container, and the active element affecting the characteristics of said liquid or measuring attributes of said liquid.

The present invention was inspired by a drive to address all of the above in some form or another and can be implemented by attaching an universal connector to the container, through a number of methods (as will be described herein below) and then attaching inserts through a number of methods (as will be described below). This insert can extend in either direction as needed. According to its intended function, the insert would perform a treatment or analysis of the liquid inside a container. The insert could include an internal cavity extending from the base to well within the bottle, and may be near to the neck, for accepting an insert for cooling or heating the bottle as well as infusing elements, adding decorative lighting or graphics in addition to enabling IOT functionality. Such inserts could be made available from retail outlets, and vended with the bottle or separately thereto for insertion into a user's previously purchased bottle, for cooling o treating the bottle contents. This would enable a vending outlet to stock chilling [and/or treatment] inserts that would take up far less room than full bottles of beverages. Also, one could have a heat exchange rod that is couplable to a socket, such as a cigarette lighter [in a motor vehicle] or USB port and may be used to rapidly chill or heat the contents of a bottle into which it is inserted.

Alternatively, such an internal cavity could be used for accommodating an insert that provides flavor, vitamins, additive, an infusion or pharmaceuticals, and that can be detached from the cavity of the bottom of the container and inserted into the neck of the bottle to bring into fluid contact with the contents of the bottle.

Other objects, features and advantages of the present invention will become apparent upon reading the following detailed description in conjunction with the drawings and the claims.

### BRIEF DESCRIPTION OF THE FIGURES

For a better understanding of the invention and to show how it may be carried into effect, reference will now be made, purely by way of example, to the accompanying Figures, wherewith it is stressed that the particulars shown are by way of example and for purposes of illustrative discussion of the preferred embodiments of the present invention only, and are presented in the cause of providing what is believed to be the most useful and readily understood description of the principles and conceptual aspects of the invention.

FIG. 1 is a side view of the universal connector in accordance with a first embodiment of the invention.

FIG. 2 is a longitudinal section through the universal connector of FIG. 1.

FIGS. 3a and 3b are vertical views of an exploded view and an assembled view of the universal connector in combination with a standard beverage container or bottle.

FIG. 4a is an exploded side view of the universal connector in combination with an active element; FIG. 4b is a side view of them assembled; FIG. 4c is a top view of the assembly.

FIG. 5a is an exploded view showing the universal connector, the active member and a container; and, FIG. 5b is a view of them assembled together.

FIG. 6a is an exploded side view showing the universal connector, an adapter and a container; FIG. 6b is a top view of the universal connector and the adapter; and, FIG. 6c is a top view of the adapter.

FIG. 7a is a view similar to FIG. 6a, but showing multiple adapters; FIG. 7b is a top view; and FIG. 7c shows a top view of multiple adapters.

FIG. 8 shows adapters for affixment to bottle necks of different sizes.

FIG. 9a is a side view of an assembled extender and FIG. 9b is an exploded view.

FIG. 10a is an exploded view showing the universal connector, the extender, the active member and a container; and, FIG. 10b is a view of them assembled together.

FIGS. 11a and 11b are a top and a side view of a connector for centering the active element.

FIG. 12a is an exploded view showing the universal connector, the centering connector, the active member and a container; and, FIG. 12b is a view of them assembled together.

FIG. 13 is a side view of a collar of universal connector of an elastic or resilient material

FIGS. 14a and 14b are side views showing the universal connector of an elastic or resilient material; FIG. 14c is a side view; 14d is an exploded view with the container; and, FIG. 14e is a view of the completed assembly.

FIGS. 15a and 15b show an active member configured as a cooling rod and also a container with this cooling rod.

FIG. 16 shows a device where the active element is constituted as an infuser.

FIG. 17a shows a side view of an universal connector made as a resilient member, such as silicon; FIG. 17b shows a side view of the resilient member with a sleeve for the active member; FIG. 17c is a top view of the resilient member; and FIG. 17d is a view showing both the resilient member and the sleeve for the active element.

FIG. 18a shows the resilient member in a bottle with the sleeve for the active element, FIG. 18b is without the sleeve for the active member; and FIG. 18c shows a resilient member with a magnetic surface and a corresponding magnetic sleeve around the outside of the bottle to hold the resilient member in place.

FIG. 19 shows an alternate embodiment with support legs to position or hold the universal connector or active member within the interior of the container.

FIG. 20 shows various configurations of the support legs.

FIG. 21a shows a container of a fluid constituting the active member; FIG. 21b shows the universal connector affixed to this active member; and FIG. 21c shows the duel flow of both liquids.

FIG. 22. shows a universal connecter with a sensing device.

FIG. 23 shows a logic diagram of a typical sensor.

FIG. 24a shows a preform for manufacturing a blow molded plastic bottle with a connecting surface on the interior of the mouth; FIG. 24b shows a plastic bottle manufactured with that Preform and an attachment with chill rods that can be threaded or snapped into the interior of the mouth of the bottle; and, FIG. 24 c shows the bottle assembled with the chill rods.

FIG. 25a shows a bottle with a compartment for an active member; FIG. 25b shows insertion of a chill rod through the bottom of the bottle; and, FIG. 25c shows the bottle assembled with the chill rod.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In a basic embodiment, the Invention constitutes a device for treatment or analysis of the liquid inside a container, comprising: an universal connector having a first part for affixment to a portion of the container and a second part extending from the first part and made integral therewith; and, an active element for affixment to the second part of the universal connector and extending from the second part into an interior storage area of the container, and the active element affecting the characteristics of the liquid or measuring attributes of the liquid.

According to an embodiment, the universal connector engages the container between a neck and a lid of the container. The universal connector can have a first screw thread for engaging a screw thread around the neck of the container, and a second screw thread for affixment of the active element to the universal connector. Additionally, the universal connector can engage the container by threading or a friction or snap fitting or the active member engages the universal connector by a friction or snap fitting. Moreover, an adapter ring facilitates affixment of the universal connector to said container.

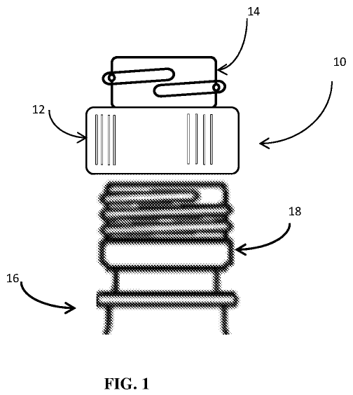

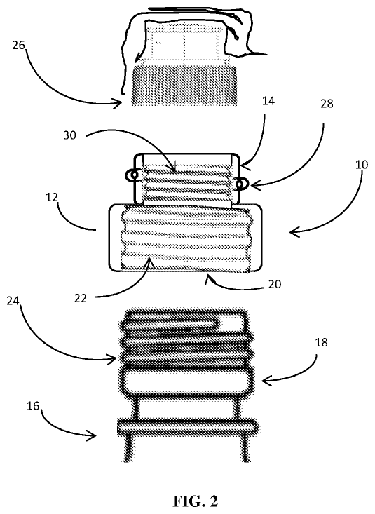

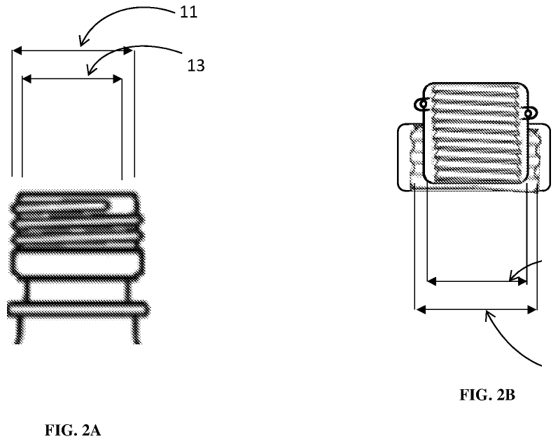

FIG. 1 is a side view of an universal connector 10 in accordance with a first embodiment of the invention and it consists of a collar 12 that engages the neck 18 of a bottle 16 (or other suitable container), and a neck 14 attached and extending upwards from the collar 12. FIG. 2 is a longitudinal section through the universal connector 10 of FIG. 1. It shows that the collar may be provided with an internal screw thread 22, i.e. a female screw thread, for engaging the neck 18 of a bottle 16.

The interior surface 20 of the collar 12 is finished with a connecting surface for affixment to the bottle/container. In the preferred embodiment, the interior surface 20 of the collar is threaded 22 to match the thread 24 on the outer surface of the neck 18 of the container 16.

Regarding the neck of the universal connector, it preferably is threaded both externally and internally. If desired, a closure cap or drinking cap 26 may be threaded onto corresponding threads on the outer surface 28 of the neck 18 of the universal connector 20. By this means, the container can be sealed to avoid spillage or utilized for drinking. The internal surface, such as threads, of the neck may be used for affixment of the active member, as hereinafter explained.

Typically, the universal connector is made of any suitable material and, in the preferred embodiments, it is made of plastic. Further, the universal connector is preferably made as a unitary single piece with the collar and neck made integral into one single piece. As shown in FIGS. 3a and3b, in most embodiments, the universal connector is screwed onto the threaded neck of the container. Alliteratively, it can be a friction or snap fit.

The interior of the neck 14 of universal connector is finished with a connecting surface 30 for affixment of the active element, as hereinafter described. This connecter surface on the internal circumference preferably stops at the potion that attaches to the container.

In a preferred embodiment, the clearances between the inner wall of the device that threads on to the mouth of the container and the outer surface of the wall of the extended fastener surface can be made to match clearances of the walls of the mouth of a container (see FIG. 2a).

The material of the extended portion can be ridged material and would be specific in size to match the container mouth wall measurements. Alternatively, it can be a pliable material e.g., a silicone material that would be flexible to adapt to multiple measurements.

It will be appreciated that not all screw threaded bottle caps correctly engage the threads on the necks of all bottles. There is actually a small but finite range of diameters and threads that are applied to different bottles.

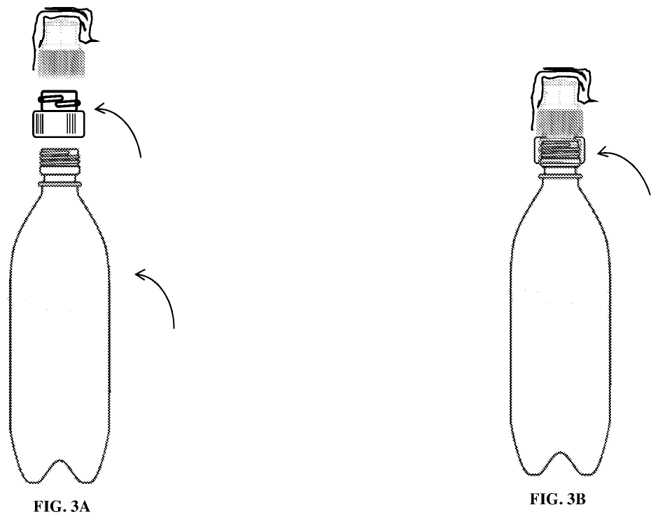

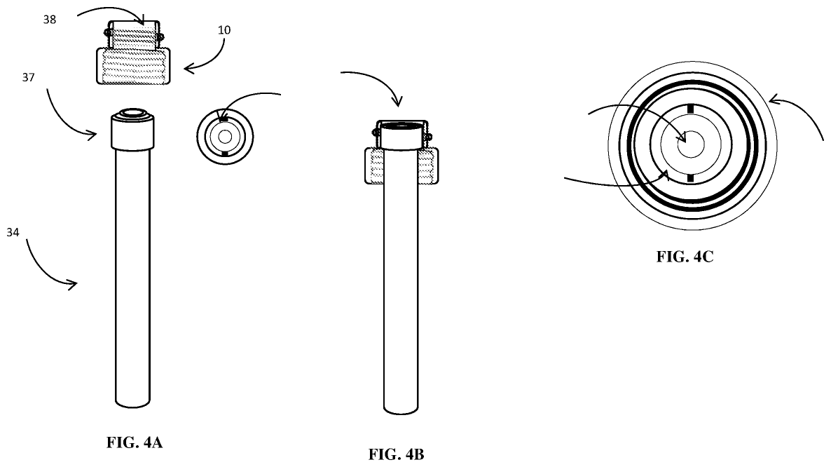

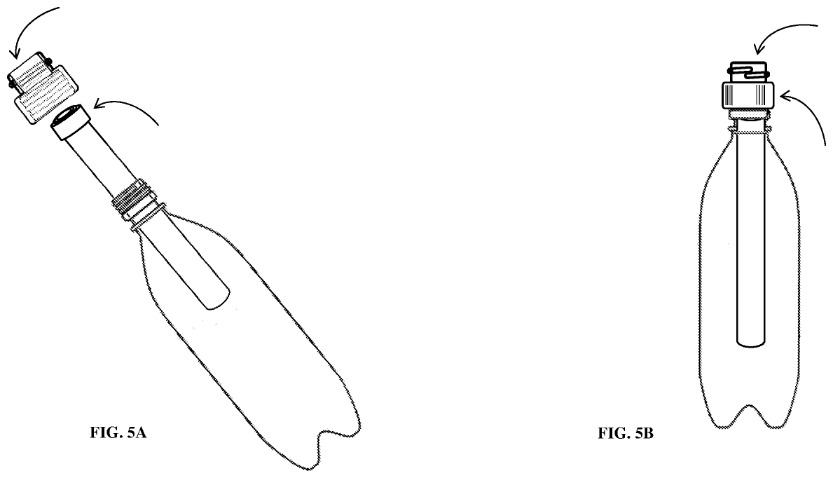

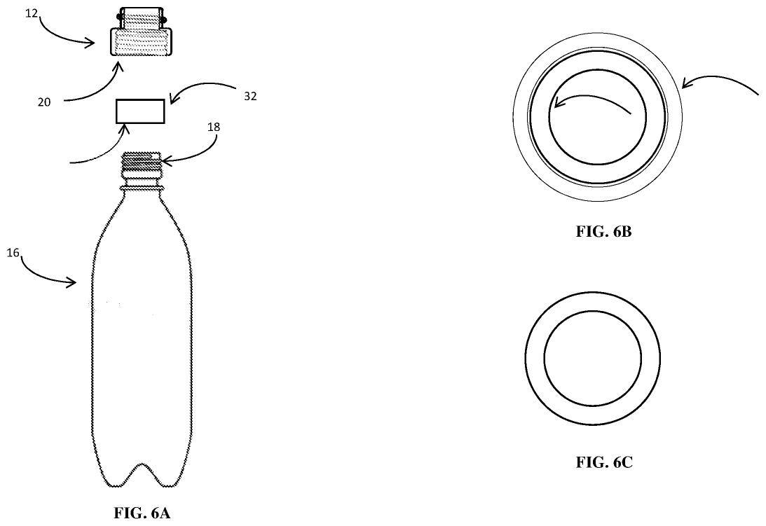

As may be appreciated, there are innumerable neck sizes of containers. The opening and threads are made to fit specific size bottle necks. Thus, the universal connector of this invention can obviously not fit onto these myriad sized containers. Therefore, in preferred embodiments, the device may additionally include an adaptor 32 (FIG. 6). The opening has adapters that, thereby, allow the same device to fit a number of different bottle necks sizes and threads types.

An elastomeric inner gasket or adapter 32 is provided within the collar 12 of the universal connector 10 for flexibly engaging the threads of any of a range of bottles. In this instance, the elasotomeric inner gasket may comprise silicone rubber. This has sufficient resilient flexibility to lockingly engage male screw threads with different pitches and configurations to provide a water tight seal, and indeed to significantly reduce carbon dioxide leakage, keeping carbonated beverages fizzy.

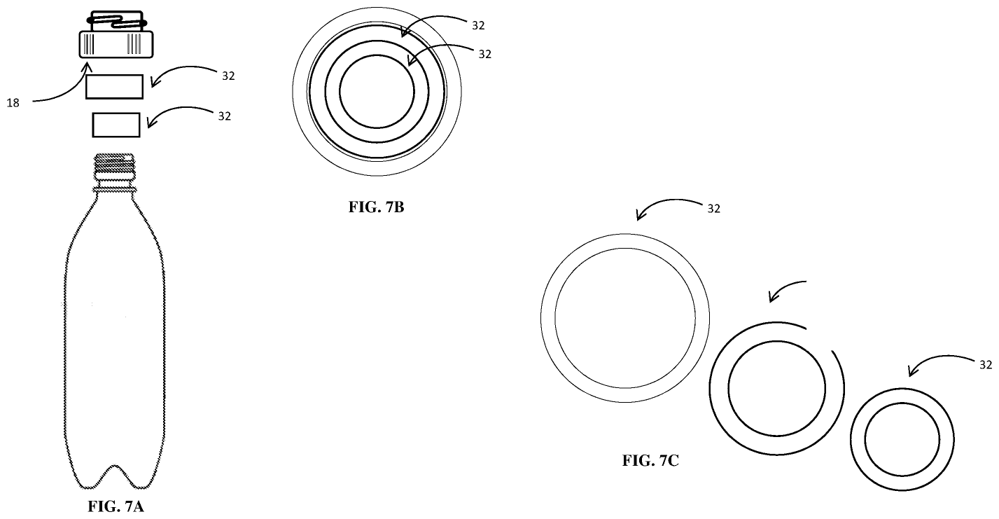

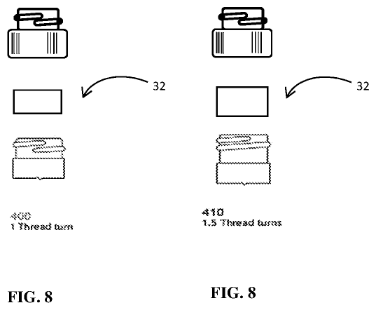

As shown in FIGS. 6-8, an adapter 32 is provided to permit the universal connector to be securely attached to the neck of the bottle/container. Generally, the adapter is a [relatively] thick flexible gasket. The inner diameter is sized to fit over the neck 18 of the bottle 16. Similarly, the outer diameter of the adapter is sized to fit within the interior connecting surface 20 of the collar 12 of universal connector. By this means (see FIGS. 8a-8c), the adapter compensates for the differences in size between the collar of the universal connector and the neck of the bottle and/or the different thread types. In some cases (see FIG. 7), multiple nesting adapters may be utilized to permit the connection of the universal connector to the neck of the bottle/container.

There are multiple neck sizes and threads that the universal connector needs to fit. The adapter's outer surface connects (by a thread or a snap or friction fit etc.) to the inner surface of the collar of the universal connector. While the inner surface of the adapter fits the bottle neck size/threads. This enables the universal connector with the adapter in place to accommodate multiple neck sizes and threads types.

Since, there are multiple neck sizes and threads that the universal connector needs to fit, there can be multiple adapters. The larger adapter fits in the surface and connects (thread snap etc.) to the inner surface of the universal connector. The small adapters fits in the larger adapter and connects through connects (thread snap etc.) to the bottle/container. With one or two (or sometimes even more) adapters in place the universal connector can accommodate bottles/containers with multiple neck sizes and threads types.

FIG. 8 shows the neck of a bottle/container having a 400 thread and a single thread turn and an appropriate adapter ring for interfacing between the inner diameter of the collar of the universal connector and the neck of the bottle; and, it also shows the neck of a different bottle having a 410 thread and one and a half threads turn and an appropriate adapter ring for interfacing between the inner diameter of the collar of the universal connector and the neck of a different bottle having a 410 thread and one and a half threads turn. The adaptor rings individually lockingly engage the inner part of the collar of the universal connector.

It will be appreciated that although two adaptor rings for conforming the universal connector by providing appropriate female screw treads for attaching to two different standard screw male screw threads around the mouth of different bottles are shown, an universal connector of this embodiment may be provided with a range of adaptor rings for lockingly engaging the inside of the collar and for screwingly engaging the various male screw threads around the mouths of various common beverage bottles.

The herein disclosed invention is for the purpose of treatment or analysis of the liquid inside a bottle/container. This aspect is accomplished by an active element 34 which is affixed to the second part (neck) 14 of the universal connector 10 and extending from the second part into an interior storage area 36 of the container (bottle) 16, and the active element affecting the characteristics of the liquid or measuring attributes of the liquid.

As shown in FIGS. 4a and 4b, the active element 14 can, preferably, be made as an elongate cylinder. One end 37 is threaded to engage threads on an interior surface 38 of the neck 14 of the universal connector 10.

Depending on the desired embodiment, the active element may include monitoring or sensing elements monitoring ingredients of the liquid or flow of the liquid or measuring chemical composition, acidity or temperature of the liquid. The active element may be, inter alia, an infuser, a heating element, a cooling element or an heat exchange device. Further, the active element can provide colorings, flavorings, vitamins, alcohol, additives, infusions, mineral supplements or pharmaceutically active ingredients into the liquid.

As shown in FIGS. 5a and 5b, the active member connects to the interior of the neck of the universal connector and extends into the interior of the bottle/container.

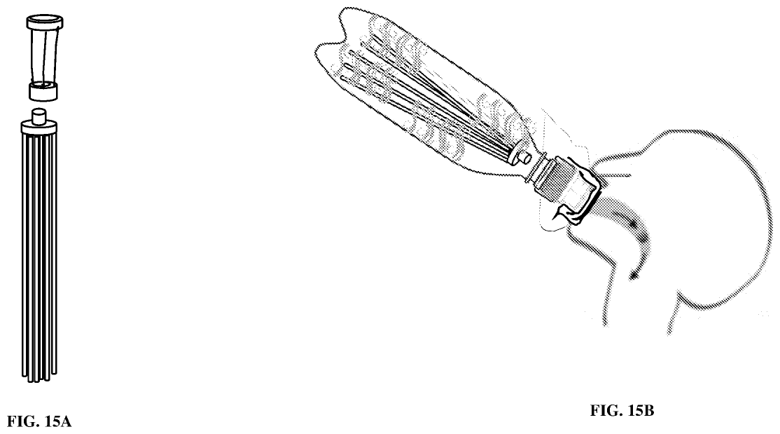

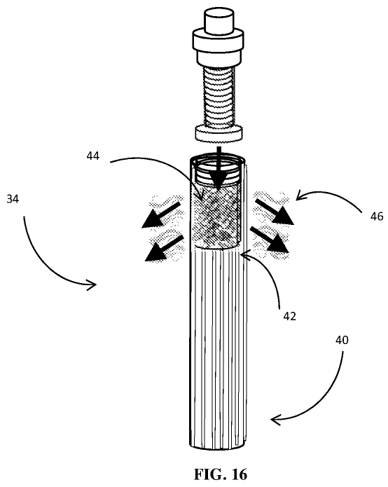

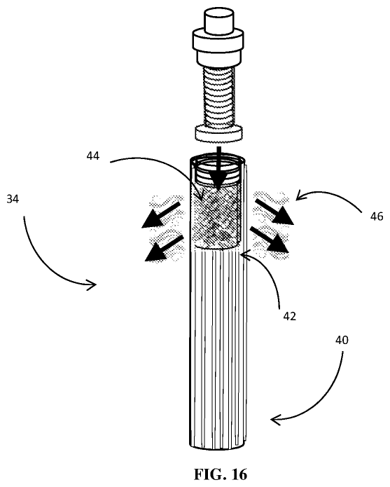

In one embodiment, FIGS. 15a and 15b show an active member configured as a cooling rod(s). There can be a cluster of thin frozen rods. Because each thin rod floats independently, it circulates more in the water, thereby chilling and infusing more efficiently. In one version the rods can be dehydrated fructose that will infuse the water with flavor. The individual rods move independently which allows more surface area exposed to the water, which will chill and infuse flavor and nutrients in to the water more effectively. FIG. 15b shows a graphical representation of water circulating around individual rods as they move.

All the embodiments of universal connectors described herein are variations that enable coupling to different bottles/containers and/or for attachment of different type of active elements.

With reference to FIG. 5, the basic concept of the universal connector is shown. It fits between the lid (or cover) and the neck of a bottle (or any type of container), thereby enabling the bottle and lid to perform their standard functions. Thus, the universal connector may be fitted to existing bottles, whether a bottled beverage by the vendor or to a purchased bottled beverage or to a bottle filled with tap water or the like.

It is considered that this invention offers new functionality and opens new sales opportunities. In one embodiment, the active element can be a rod with a reservoir of an additive, such as at least one of colorings, flavorings, vitamins, alcohol, mineral supplements and pharmaceutically active ingredients. It could alternatively be a reservoir of dry baby formula, allowing a parent to add dry formula to a bottle of boiled water, regular tap water or spring water. In such an instance, the lid could be replaced with a nipple, for example. The lid could also be replaced with a drinking spout.

Alternatively, the active element can be a rod filled with water and storable in an ice box. Such a rod could be manufactured like a popsicle, but could adequately chill a bottle of water, saving the need for large refrigerators in vending outlets. This is a significant advantage over the current system where the need to have refrigerators for large bottles, and the limited size of refrigerators in stores and even more so in snack vans and the like, forces vendors to sell chilled beverages at a premium. One could conceive of an ice-cream van with limited storage space selling frozen rods for consumers to add to their previously purchased bottled beverages at ambient temperatures. One could also consider such vans being restocked with bottled beverages at ambient temperatures and being able to thereby provide chilled drinks more easily. As with gel packs used for keeping shopping purchases and picnics fresh, hydroxy-ethyl cellulose (Cellusize), sodium poly-acrylate, or vinyl-coated silica gel could be added.

Alternatively, the active element can be a rod with a heating element and could be heated, perhaps by connecting to a cigarette lighter socket or the like in a car, and used to warm the beverage. This could be to bring baby formula to body temperature, for example.

Alternatively, again, for use to cool a beverage bottle in the field, at a picnic, sports event, camping holiday, military, etc, the active element could be an instant cold pack. Instant cold packs are devices that consist of two bags; one containing water, inside a bag containing ammonium nitrate, calcium ammonium nitrate or urea. When the inner bag of water is broken by squeezing the package, it is allowed to dissolve the solid in an endothermic reaction. This reaction absorbs heat from the surroundings, quickly lowering the pack's temperature. Instant cold packs are sometimes used as first aid on sport injuries, and can be carried as first aid to remote or wilderness areas where ice is unavailable. The instant cold pack could be provided as a rod.

It will be appreciated that the active element need not be a single unit, and need not be rod shaped, and can be any suitable design to achieve any required functionality.

FIG. 16 shows a device where the active element 34 is constituted as an infuser 40. The infuser attachment includes a silicon accordion (spring) pressured plunger to maintain pressure. The pressure on the internal fruit pieces 44 forces juice out through the vents 42 in the side and into the water 46 that is flowing through the vents.

According to an alternate embodiment, the Device further comprises an extender, said extender having a first end for affixment to the universal connector and a second end for affixment to the active member. Preferably, the first end of the extender having a larger diameter than said second end of the extender, thereby effectively lowering the active member further into the interior storage area of said container and spacing the active member from a neck of the container, thereby facilitating flow of liquid through and out of said container.

In another embodiment, the Device further comprises a centering connector, said centering connector having a first end for affixment to the universal connector and a second end for affixment to the active member, thereby facilitating flow of liquid through and out of said container.

Another embodiment includes an extender having a first end for affixment to the universal connector and a second end for affixment to the active member. The first end of the extender can have a larger diameter than the second end of the extender, thereby effectively lowering said active member further into the interior storage area of the container and spacing the active member from a neck of the container, thereby facilitating flow of liquid through and out of the container.

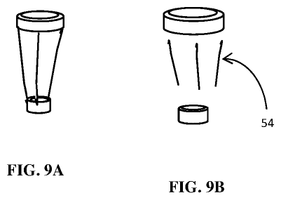

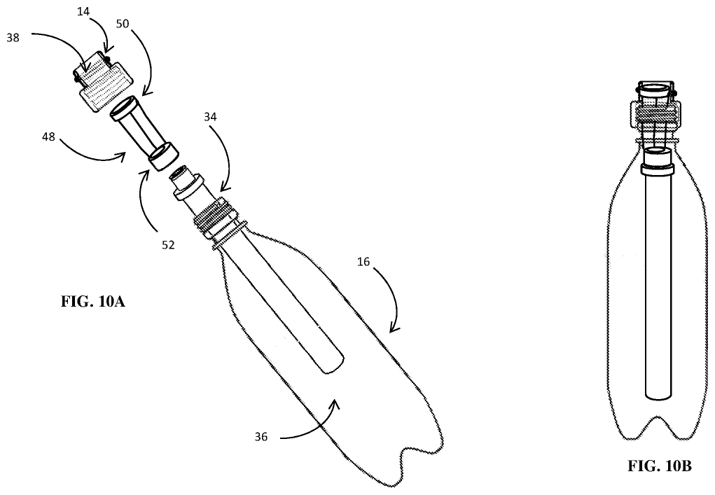

It may be appreciated that in some embodiments (see FIGS. 9 and 10), an extender 48 is required to lower the active member 34 further into the interior 36 of the bottle 16. In a preferred embodiment, a larger end 50 may be threaded and it engages the interior surface 38 of neck 14 of universal connector. The active element 34 is threaded onto the smaller end 52.

As shown in FIG. 9b, the ends may be fashioned as rings. A plurality of string like ribs 54 connect the rings, and allow the liquid to flow through the extender.

In some embodiments, there is additionally a centering connector. The centering connector has a first end for affixment to the universal connector and a second end for affixment to the active member, thereby facilitating flow of liquid through and out of the container.

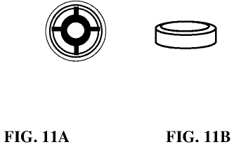

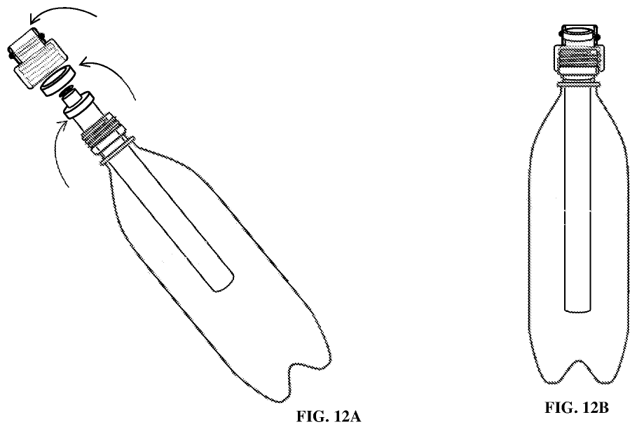

FIGS. 11a and 11b are a top and a side view of a connector for centering the active element. FIG. 12a is an exploded view showing the universal connector, the centering connector, the active member and a container; and, FIG. 12b is a view of them assembled together.

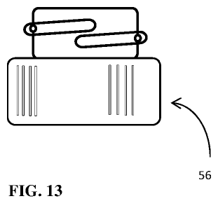

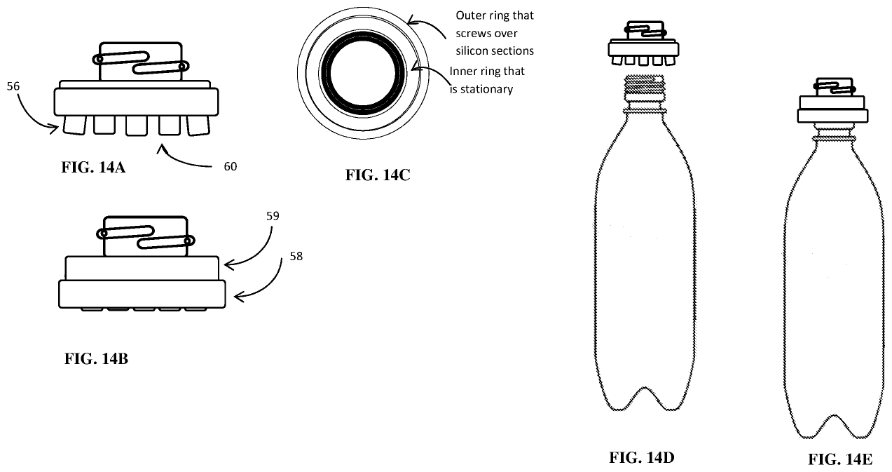

As shown in FIG. 13, the collar of universal connector may be instead made of an elastic or resilient material. In particular, the silicon collar can adjust to multiple neck sizes and threads of the bottle/container to which the universal connector needs to be attached. In a preferred embodiment, as best shown in FIGS. 14a and 14b, the silicon collar 56 may have interlocking rings 58 along the outside surface. The interlocking rings are threaded over the silicon collar, which is made of connected ribs which are wider on the bottom than the top. To attach the universal connector to a bottle, the larger interlocking ring 58 screws over the smaller interlocking ring and over the outside surface of the silicon ribs, which have female threading. Since the ribs are wider on the bottom than the top, the collar creates a tension as it is tightened, thereby forcing the silicon against the bottle neck for a tighter fit.

As shown in FIG. 14, more particularly, the silicon base has ribs along its outside surface. The ribs 58 are threaded, and the silicon ribs are shaped with a thinner layer connecting them that allow greater compression while retaining a water tight seal. A collar screws on to hard plastic strips(ribs) on the outside surface of the silicon. Since the ribs are wider on the bottom than the top, the collar creates a tension as it is tightened, thereby forcing the silicon which, with its slotted design, to compress against the bottle neck and maintain a solid connection, thereby adapting to different varieties of sizes, threads and shapes, while still maintaining a water tight fit. The universal connector can preferably be provided with a silicone collar 56 for allowing the collar of the universal connector to engage different diameter bottle necks with different thread pitches and/or diameters. The collar need not be fully fabricated from silicon, and may have an outer skin of a stiffer plastic such as PP, BST, PS, and so on. Furthermore, the outer skin may be continuous or may have slits 60 in it, or it may comprise isolated scales of stiff plastic mounted on the silicone collar.

The universal connector can preferably be provided with a silicone collar 56 for allowing the collar of the universal connector to engage different diameter bottle necks with different thread pitches and/or diameters. The collar need not be fully fabricated from silicon, and may have an outer skin of a stiffer plastic such as PP, BST, PS, and so on. Furthermore, the outer skin may be continuous or may have slits in it, or it may comprise isolated scales of stiff plastic mounted on the silicone collar.

In another embodiment, the universal connector consists of a resilient member with a central opening throughout its length. More particularly, the universal connector consists of a resilient hollow conduit or tube, such as silicon. The silicon stopper stays in place using pressure created around the neck of the bottle/container.

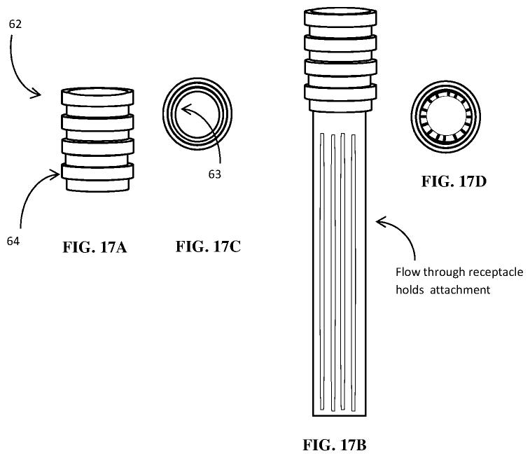

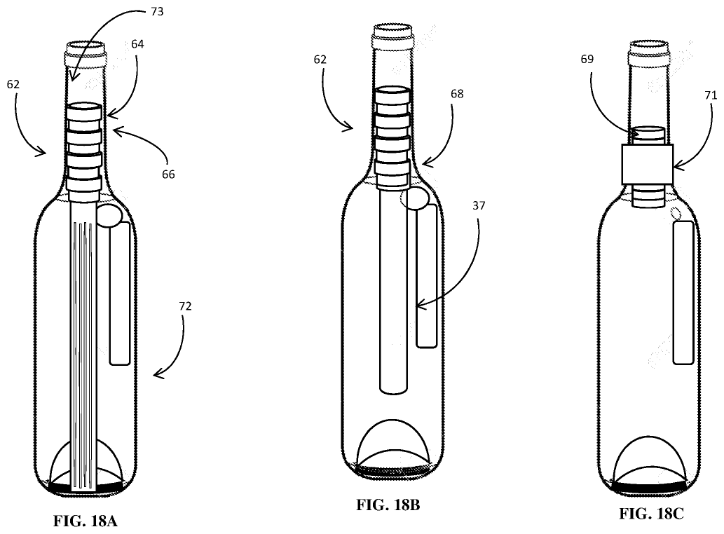

FIG. 17a shows a side view of an universal connector made of a resilient member 62, such as silicon; FIG. 17b shows a side view of the resilient member with a sleeve for the active member; FIG. 17c is a top view of the resilient member; FIG. 17c is a view showing both the resilient member and the sleeve for the active element; and, FIG. 17d is a top view showing both the resilient member and the sleeve for the active element. FIG. 18 shows the resilient member in a bottle.

The resilient member 62 is made of any suitable resilient or flexible material, such as silicon. To increase the frictional fit, the surface of the resilient member may have ribs 64. The upper portion 66 of the resilient member is pressed into the internal surface of the container and held by frictional pressure. A connecting surface can also used to hold the top portion 37 of the active element within the lower end 68 of the resilient member 62.

Alternatively, the resilient member can be similarly affixed to the aforesaid active member.

As shown in FIGS. 18a and b, tension can hold the resilient member with the active element in the mouth of the bottle. FIG. 18a shows the resilient member in a bottle with the sleeve for the active element, FIG. 18b is without the sleeve for the active member; and FIG. 18c shows a resilient member with a metal or magnetic surface 69 and a corresponding magnetic sleeve 71 around the outside of the bottle/container to hold the resilient member in place.

In another embodiment, support legs position or hold the universal connector or active member within the interior of the container.

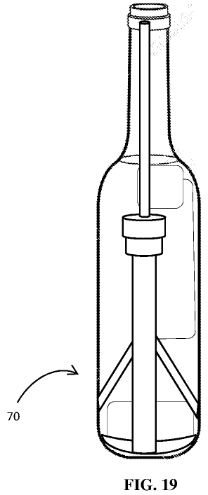

FIG. 19 shows one embodiment of support legs. The device can use multiple means to secure the universal connector or active member [or a sleeve for the active member] within the bottle, including using weighted/gravity, tinsel pressure or magnetic force.

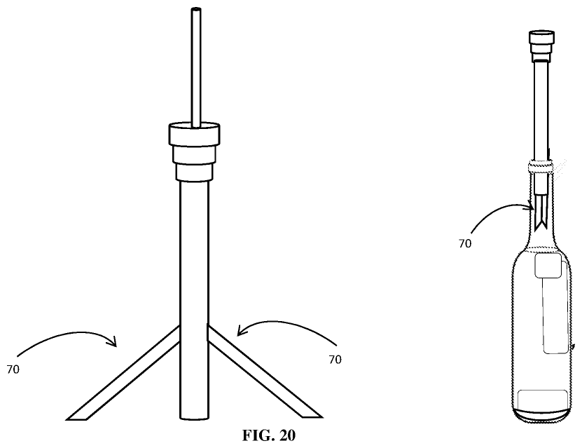

There are many other ways of holding the active member securely within a bottle. For example, with reference to FIGS. 19 and 20, the resilient member 62 has folding legs 70. These legs may be folded together and inserted into the neck of a bottle. Once within the bottle, legs unfold to bear against the sides and/or bottom of the bottle to hold the active member securely in position. It is also possible for the active member to bear against the bottom (or other inner surface) of the bottle for support.

According to one embodiment, the universal connection includes a sleeve and the active member is within the sleeve and includes means for treatment or analysis of the liquid.

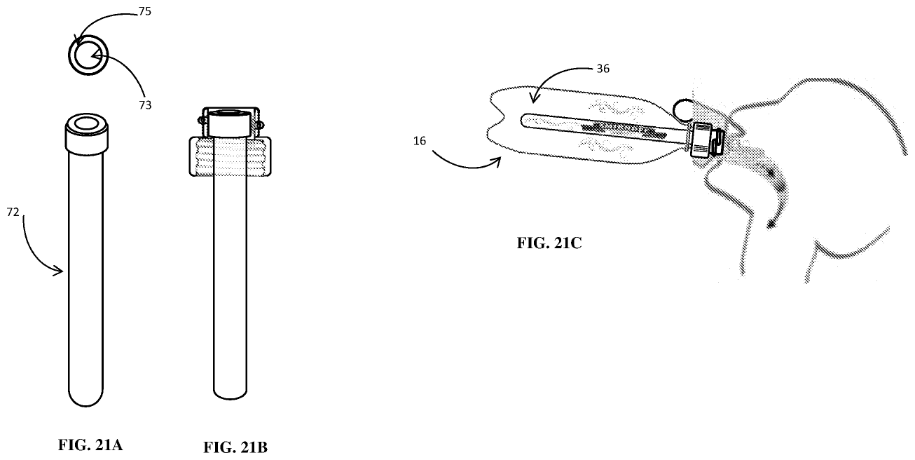

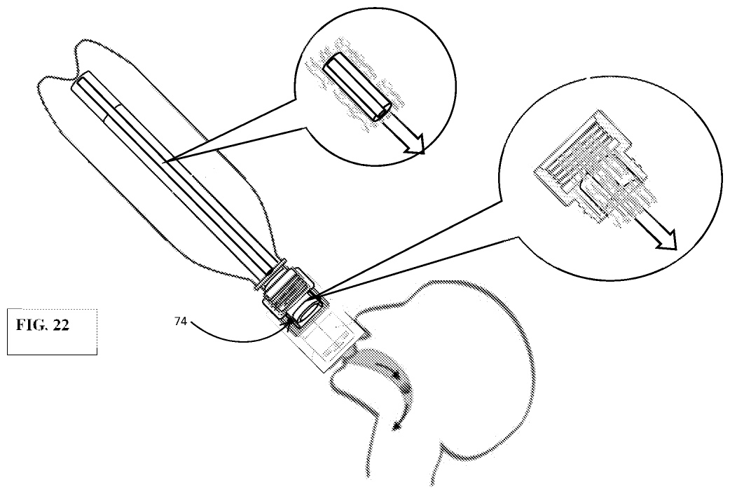

FIG. 21a shows a container of a fluid constituting the active member; and FIG. 21b shows the duel flow of both liquids.

In particular, a container 72 of fluid may be incorporated as the active member. This container may be filled with any desired fluid, such as fruit juice, alcohol, sports drinks and any other desired beverage. This container 72 is open at the top so the fluid exits from the container 72 and mixes with the fluid in the main chamber 36 of the bottle 16. The view from the top shows that the active element container is open 73 and the bottle mouth is open 75, so the fluid exits from the container 72 and mixes with the fluid in the main chamber 36 of the bottle 16. It is also possible for the container 72 to be porous or to have vents for the exiting of the fluid, or to use another appropriate slow release design. As shown in FIG. 21b, when the user tilts the bottle to drink, the fluids mix and the user gets the benefit of both liquids.

The additional container 72 can include, for example, a dosage of alcohol, such as vodka for addition to a beverage such as Coca Cola, to make a cocktail such as Coke & Vodka, or tomato juice to make a Bloody Mary, for example. In some embodiments, the universal connector includes an insert that monitors parameters of the liquid contained within the bottle, such as flow rate, chemical composition, etc.

FIG. 22. shows a universal connecter with a sensing device 74.

A variety of monitoring elements can be used with the universal connector to monitor the ingredients of the contents and/or the flow from the bottle/container. The universal connector may include a flow meter for measuring the amount of liquid poured from the bottle. For example, the universal connector could include a mechanical flow meter comprising a paddle or an Archimedean screw and a counter, for counting the turns of the paddle or screw. Alternatively, or additionally, the universal connector may include a sensor, such as an optical fiber sensor, for measuring the chemical composition or the temperature of the beverage. The universal connector may include a pH meter which may be electronic or may comprise an indicator dye, such as litmus or universal indicator, for indicating the acidity of the content. This could be used to indicate degradation, since microbes and the like tend to change the pH of a beverage over time. For example, wine turns to vinegar, accompanied by an increase in pH. In addition to the formation of acetic acid, the formation of lactic acid also changes the pH of a beverage.

It may be appreciated that the sensing element may also be included in the active member instead of the universal connector, or be an attachment to either.

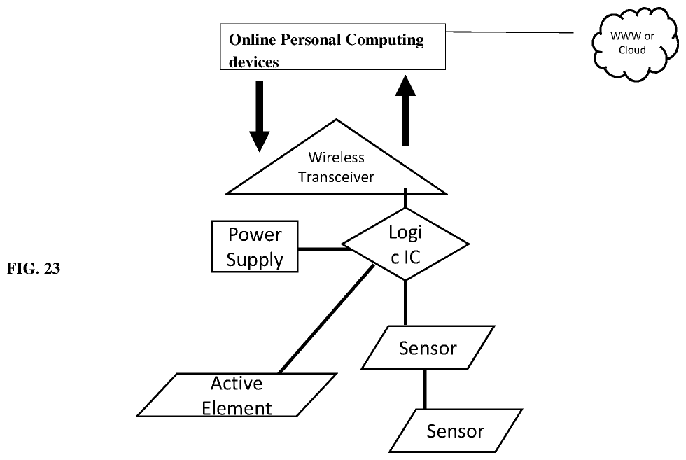

FIG. 23 shows a logic diagram of a typical sensor and also shows alternative types of sensors. The conceptual block diagram of the functional elements of the sensor typically include a power supply, a sensor, logic circuitry and a wireless (such as blue tooth) transmitter of RF signaler for communication with an external device, such as a personal computing device or Smartphone or the like, enabling the sensor to communicate with the outside world. In this manner, the active element can be activated by the external device. Further, information about the liquid may be shared with the external device.

Preferably, in another embodiment, there is also a means for electronically connecting the device to an external device for sharing relevant information about the liquid or displaying relevant information on the external device or the external device controlling functioning of the active element. The active element or the universal connector includes monitoring or sensing elements monitoring ingredients of the liquid or flow of the liquid or measuring chemical composition, acidity or temperature of the liquid. Further, the external device is selected from the group consisting of a personal computing device, a smart phone, a tablet, a laptop computer, a desktop computer, wearable monitoring devices, IoT interrelated devices, and information services accessible via the Cloud or Internet or Computer networks.

In another embodiment for a bottle communicates with a smart phone (or other external device)to monitor and report fluid consumption and content to a user. Here the smart-phone runs an App. that causes it to remind the user to drink regularly, and may be coupled to other Apps that monitor the user's activity, the ambient temperature and so on, to prevent dehydration or supply the body with needed nutrients.

Another embodiment includes a system for treatment or analysis of the liquid inside a container, comprising: a preformed container having a longitudinal compartment extending up into an interior storage area of the container and the compartment having an opening contiguous with a bottom portion of said container; and, an active element for affixment to the opening of the compartment and extending within said compartment into said interior storage area of said container, and the active element affecting the characteristics of said liquid or measuring attributes of said liquid.

According to another embodiment, the universal connector being made integral with said container. In particular, this can be accomplished by a preform.

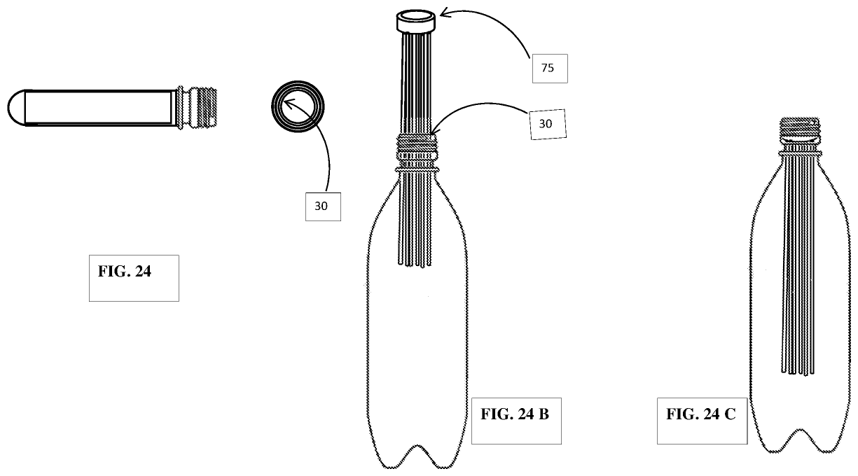

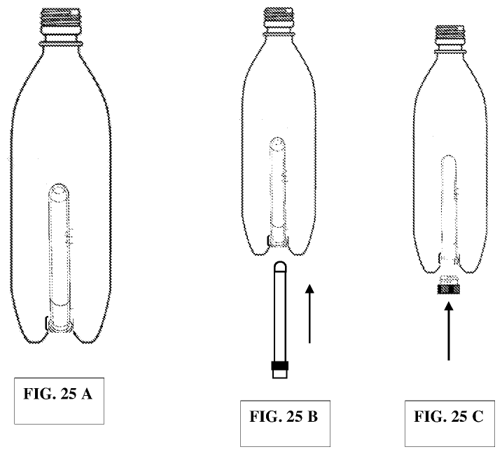

FIG. 24a shows a Preform for manufacturing a blow molded plastic bottle with a connecting surface on the interior of the mouth; FIG. 24b shows a plastic bottle manufactured with that Preform and an attachment with chill rods that can be threaded or snapped into the interior of the mouth of the bottle; and, FIG. 24c shows the bottle assembled with the chill rods.

FIG. 25a shows a bottle with a compartment for an active member; FIG. 25b shows insertion of a chill rod through the bottom of the bottle; and, FIG. 25c shows the bottle assembled with the chill rod. The compartment is created in the blow mold process by using a mold with the relief shape for the compartment for an active member.

In general, due to their ubiquity, embodiments of the invention will generally be used with PET (polyethylene tetraphalate) bottles. These are supplied as a sort of test-tube like former with a screw thread to various bottling plants around the world. This preform is expanded by blowing into a mold and it is then filled, capped and labeled. Typically, the preform for a Pet bottle of the prior art is provided with an external screw thread for engaging the cap, which is usually forced over the expanded bottle under pressure in bottling plants, which is why it is often provided with the lid coupled to a detachable locking ring which is left on the bottle, when the cap is unscrewed.

The embodiments described hereinabove are by way of enabling disclosure. Persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A Device for treatment or analysis of the liquid inside a container, comprising:
an universal connector having a first part for affixment to a portion of said container and a second part extending from said first part and made integral therewith; and,
an active element for affixment to said second part of said universal connector and extending from said second part into an interior storage area of said container, and
said active element affecting the characteristics of said liquid or measuring attributes of said liquid;
wherein said universal connector is integrally formed with said container.

2. A Device according to claim 1 further comprising means for electronically connecting to an external device for sharing relevant information about said liquid or displaying said relevant information on said external device or said external device controlling functioning of said active element.

3. A Device according to claim 2, wherein said active element or said universal connector includes monitoring or sensing elements monitoring ingredients of said liquid or flow of said liquid or measuring chemical composition, acidity or temperature of said liquid.

4. A Device according to claim 2 wherein said external device is selected from the group consisting of a personal computing device, a smart phone, a tablet, a laptop computer, a desktop computer, wearable monitoring devices, IoT interrelated devices, and information services accessible via the Cloud or Internet or Computer networks.

5. A Device according to claim 1 wherein said active element is selected from the group consisting of an infuser, a heating element, a cooling element and an heat exchange device.

6. A Device according to claim 1, wherein said active element provides colorings, flavorings, vitamins, alcohol, additives, infusions, mineral supplements or pharmaceutically active ingredients into said liquid.

7. A Device according to claim 1, wherein said universal connector engages said container between a neck and a lid of said container.

8. (canceled)

9. (canceled)

10. (canceled)

11. (canceled)

12. A Device according to claim 1 further comprising an extender, said extender having a first end for affixment to said universal connector and a second end for affixment to said active member.

13. A Device according to claim 12, wherein said first end of said extender having a larger diameter than said second end of said extender, thereby effectively lowering said active member further into said interior storage area of said container and spacing said active member from a neck of said container, thereby facilitating flow of liquid through and out of said container.

14. A Device according to claim 1 further comprising a centering connector, said centering connector having a first end for affixment to said universal connector and a second end for affixment to said active member, thereby facilitating flow of liquid through and out of said container.

15. A Device according to claim 1, wherein said universal connector consists of a resilient member with a central opening throughout its length.

16. A Device according to claim 1 further comprising support legs to position or hold said universal connector or said active member within said interior of said container.

17. A Device according to claim 1, wherein said the universal connector includes a sleeve and the active member is within the sleeve and includes means for treatment or analysis of the liquid.

18. (canceled)

19. A System for treatment or analysis of the liquid inside a container, comprising: a preformed container having a longitudinal compartment extending up into an interior storage area of said container and said compartment having an opening contiguous with a bottom portion of said container; and, an active element for affixment to said opening of said compartment and extending within said compartment into said interior storage area of said container, and said active element affecting the characteristics of said liquid or measuring attributes of said liquid.
